(19) United States
(12) Patent Application Publication
(10) Pub. No.: US 2015/0059217 A1
(43) Pub. Date: Mar. 5, 2015

(54) COMPOSITE SNOW PLOW APPARATUS AND METHOD

(71) Applicant: David HANSEN, Excelsior, MN (US)

(72) Inventor: David HANSEN, Excelsior, MN (US)

(21) Appl. No.: 14/538,549

(22) Filed: Nov. 11, 2014

Related U.S. Application Data
(62) Division of application No. 13/766,639, filed on Feb. 13, 2013.
(60) Provisional application No. 61/598,122, filed on Feb. 13, 2012.

(51) Int. Cl. E01H 5/06; B29C 70/44

(52) U.S. Cl. CPC E01H 5/065; E01H 5/061; B29C 70/443; B29K 2105/089
USPC 37/235; 156/60

(57) ABSTRACT

The invention includes a snow plow blade made of a composite material. The invention also includes a snow plow system that incorporates a snow plow blade made of a composite material and that further includes a mounting area for a lift mechanism and threadable metal inserts.

### TECHNICAL FIELD

Various embodiments described herein relate to a composite snow plow apparatus and a method of forming and using the same. More particularly, the present invention relates generally to snow plows for use with light and medium duty trucks, municipal trucks, as well as smaller utility vehicles such as ATVs , UTVs.

### BACKGROUND

Once the exclusive domain of municipality-operated heavy trucks, snow plows have been used with light and medium duty trucks for decades. As would be expected in any area of technology which has been developed for that period of time, snow plows for light and medium duty trucks have undergone tremendous improvement in a wide variety of ways over time, evolving to increase both the usefulness of the snow plows as well as to enhance the ease of using them. The business of manufacturing snow plows for light and medium duty trucks has been highly competitive, with manufacturers of competing snow plows differentiating themselves based on the features and enhanced technology that they design into their products.

Despite the advances in the technology, snow plows continue to be constructed of metal materials such as iron, steel, and the like. Steel is the predominant construction material due to the toughness and strength of the material as well as manufacturer's familiarity with manufacturing methods. Current snow plow products are made using steel structural elements welded to a steel mold board. Metal plows are very durable and are able to wear despite heavy duty use in plowing driveways and parking lots. Although the metal plows have met with much success, they do suffer from certain disadvantages or drawbacks. The metal plows are quite heavy, require very sturdy supporting structures, and require heavy lift mechanisms. A complete plow system, including blade, mount, lift mechanism and light rack can weigh anywhere from 500 to 1500 pounds. The high weight limits the installation of a typical snow plow system to ½ ton, ¾ ton or 1 ton pickup trucks. In fact, only the smallest systems made of the lightest gauge material are suitable for installation on a typical pickup or Sport Utility Vehicle (“SUV”) such as a Chevrolet Silverado, Suburban, or Avalanche. The high weight also limits the overall size of the blade that can be installed. Of course, this in turn limits how much snow can be removed during each pass. After a heavy snow event, it is not uncommon to utilize only ¾ or even ½ the blade width per pass. This of course slows snow removal considerably. The high weight also is hard on the front suspension system of the vehicle to which it is mounted. The weight causes premature wear and failure of the front suspension components. In many instances, warranties provided by manufacturers for new trucks are voided based on the fact that the truck was used for snow removal and snow plow equipment was mounted to the front of the truck.

The metal plows also tend to rust and require factory painting as well as rust preventative painting from time to time. Although different coating systems are employed to minimize or slow corrosion, most plow systems suffer the effects of corrosion after only one or two winters. The corrosion problem can be exacerbated by the fact that salt is often applied to melt snow or prevent clumping in sand or gravel due to moisture in these materials.

Still another problem occurs as limitations in existing steel manufacturing methods make it difficult to form the steel into complex shapes. As a result, most blades have a substantially uniform cross section throughout their width. Manufacturing steel blades with a non-uniform cross section is more difficult and therefore prohibitively expensive. The constant cross section blade profile can produce snow “stalls” or “choke points”, causing the snow to pile up in front of the blade or blow over the top of the blade rather than move along the blade to the side of the vehicle as intended. The current fix for this is to take less than a full swath of snow, which of course adds to the time needed to complete a snow removal job.

### SUMMARY OF THE INVENTION

The invention is directed to a snow plow blade made of a composite material. The snow plow blade includes woven fabric and resin. The snow plow blade also includes structural elements, such as horizontal beams and vertical ribs, made from a stiffening material, such as a foam core material and another composite material. The composite snow plow blade can also include metal inserts which are positioned to facilitate attachment of mounting brackets or accessory items such as indicator sticks or plow shoes. The metal inserts can be tapped to provide openings to receive fasteners. The metal inserts can also facilitate the attachment of wear strips to the bottom of the blade that act as a sacrificial wear element. The composite snow plow blade can be used in a snow plow system. In addition to the blade, the snow plow system includes a lift mechanism having one end attached to the composite blade for raising and lowering the composite blade, as well as angling it from side to side. The lift mechanism has another end adapted to be attached to a vehicle. The snow plow system also includes a light system for positioning at least one headlamp above the composite blade. The composite snow plow blade includes a wear strip positioned on a bottom edge of the blade.

### BRIEF DESCRIPTION OF THE DRAWINGS

FIG. 1A is a side view of a composite snow plow system attached to a pick up truck, according to an example embodiment.

FIG. 1B is a front perspective view of a composite snow plow system attached to a pick up truck, according to an example embodiment.

FIG. 2 is a cross sectional view of the composite blade portion of the snow plow system along line 2-2 in FIG. 1, according to an example embodiment.

FIG. 3 is a cross sectional view of the composite blade portion of the snow plow system along line 3-3 in FIG. 1, according to an example embodiment.

FIG. 4 is a rear perspective view of a mold for making a composite snow plow, according to an example embodiment.

FIG. 5 is a rear perspective view of a mold board portion of a composite snow plow, according to an example embodiment.

FIG. 6A is a side perspective view of a horizontal beam for use in forming a composite snow plow, according to an example embodiment.

FIG. 6B is a side perspective view of a horizontal beam for use in forming a composite snow plow, according to an example embodiment.

FIG. 6C is a side perspective view of a horizontal beam for use in forming a composite snow plow, according to an example embodiment.

FIG. 7A is a cross-sectional view of a horizontal beam shaped to receive a metal insert, according to an example embodiment.

FIG. 7B is a cross-sectional view of a horizontal beam with a metal insert positioned therein, according to an example embodiment.

FIG. 7C is a cross-sectional view of a finished horizontal beam having a metal insert, according to an example embodiment.

FIG. 8A is a rear view of a mold board with the lower horizontal beam attached, according to an example embodiment.

FIG. 8B is a rear view of a mold board with the lower horizontal beam and a set of foam core stiffeners attached, according to an example embodiment.

FIG. 8C is a rear view of a mold board with the lower horizontal beam, the set of foam core stiffeners, and an upper horizontal beam attached, according to an example embodiment.

FIG. 9 is a front view of the finished composite snow blade, according to an example embodiment.

FIG. 10 is a rear view the finished composite snow blade of FIG. 9, according to an example embodiment.

FIG. 11 is a front view of the finished composite snow blade, according to another example embodiment.

FIG. 12 is a cross-sectional side view of the finished composite snow blade 1100 along the cut line 12-12 in FIG. 11.

FIG. 13 is a rear view the finished composite snow blade of FIGS. 11 and 12, according to an example embodiment.

FIG. 14 is a rear view of the finished composite snow blade, according to yet another example embodiment.

FIG. 15 is a side view of one of the stiffening ribs, such as stiffening ribs of the finished composite snow blade (see FIG. 14), according to yet another example embodiment.

FIG. 16 is an elevational view of a bent bracket and a cross-sectional view of the bent bracket, according to an example embodiment.

FIG. 17 is an elevational view of a stop bracket 1700, according to an example embodiment.

FIG. 18 is a side view of two arcuately-shaped brackets attached to one another using several components, according to an example embodiment.

FIG. 19 is a perspective view of several reinforcing portions at the lower edge of the back side of the snow blade, according to an example embodiment.

FIG. 20 is a perspective view of an interface assembly attached to attachment ribs formed on the back side of the snow blade, according to an example embodiment.

### DETAILED DESCRIPTION

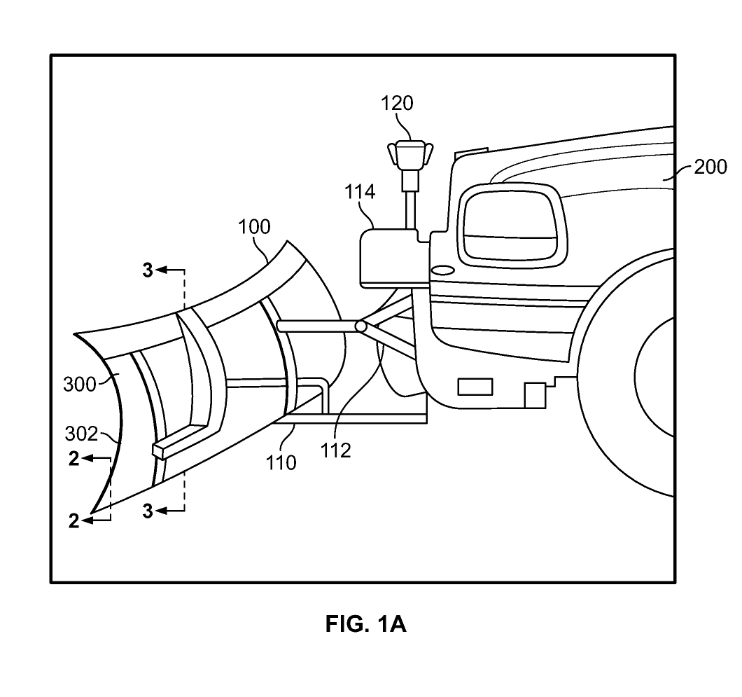

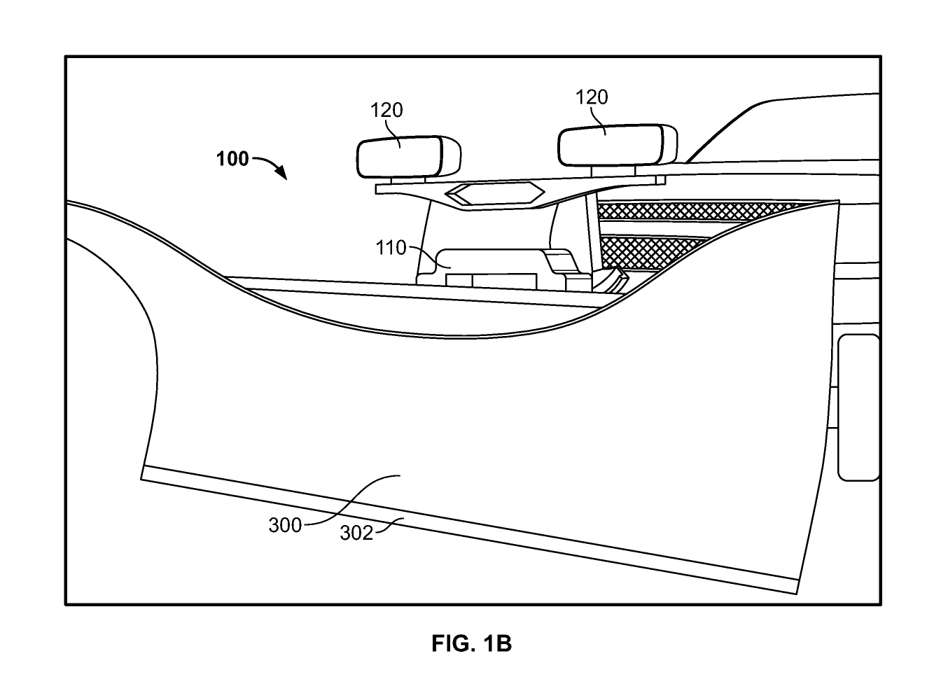

FIG. 1 is a side schematic view of a composite snow plow system 100 attached to a pickup truck 200, according to an example embodiment. The composite snowplow system 100 includes a composite snow blade 300, a lift system 110 that includes a hydraulic scissors 112. The snowplow system 100 also includes a set of headlamps 120. The lift system 110 also includes an external pump 114 which is used to pressurize the hydraulic lines used to operate the hydraulic scissors 112. The composite snowplow blade 300 also includes a wear strip 302 positioned at the bottom of the snowplow blade 300. The snowplow blade 300 can also include metal inserts positioned at the bottom of the snowplow blade 300 that correspond to the position of the wear strip 302. The snowplow blade 300 can also include metal inserts that serve as attachment points for the lift mechanism 110. The snowplow blade 300 also includes plow shoes 304. As shown in FIG. 1, only one plow shoe 304 is visible. However, it should be noted, that there are actually two plow shoes 304.

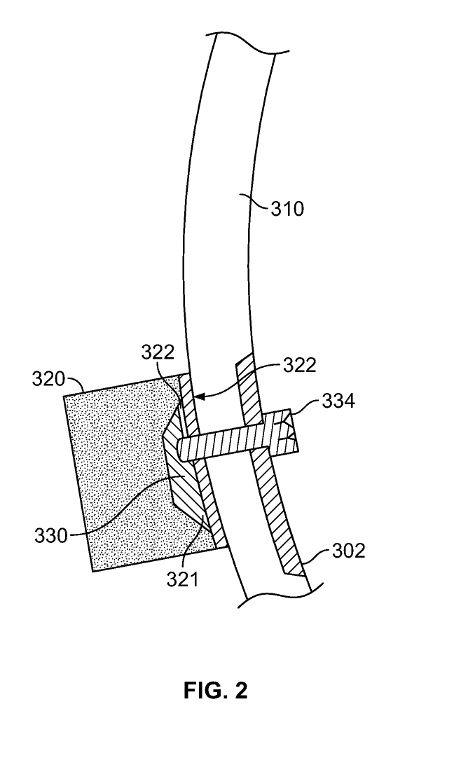

FIG. 2 is a cross sectional view of the composite blade portion of the snow plow system 100 along line 2-2 in FIG. 1, according to an example embodiment. Specifically, FIG. 2 shows the mold board 310 in cross-section along line 2-2. Attached to the mold board is a lower horizontal beam 320. The horizontal beam 320 has a cross section which is substantially triangular or trapezoidal. The triangular or trapezoidal cross-section minimizes stress concentration in the corresponding layups of fabric that are placed over the horizontal beam 320 to form the composite snow blow blade 300.

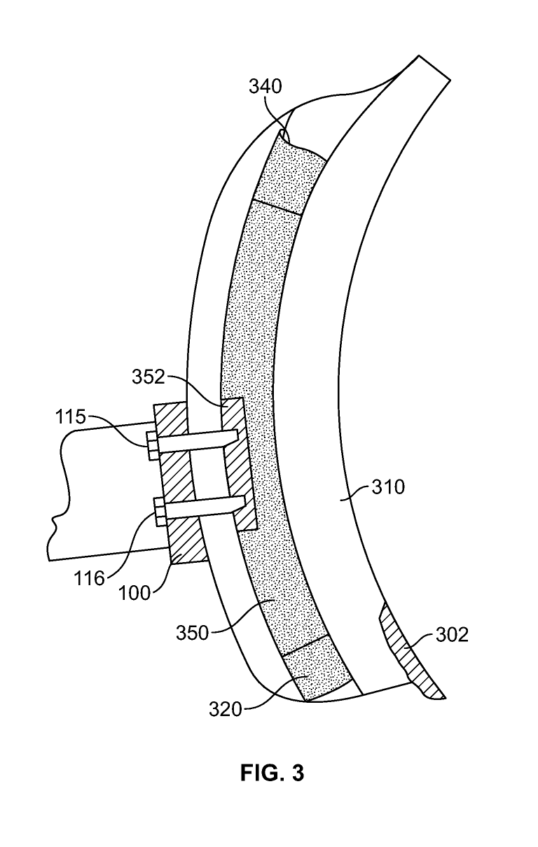

FIG. 3 is a cross sectional view of the composite blade portion 300 of the snow plow system 100 along line 3-3 in FIG. 1, according to an example embodiment. The composite blade portion 300 includes the mold board 310, a lower horizontal beam 320, and upper horizontal beam 340 and one or more foam core stiffeners 350. The foam core stiffeners 350 include a cavity for receiving a metal insert 352. The metal insert 352 is made of a metal of sufficient strength to receive and hold metal fasteners 115 and 116. In one embodiment the metal insert is aluminum. In another embodiment, the metal insert 352 is made of steel. Steel, although less corrosion resistant than aluminum, is more capable of holding the threaded fasteners 115, 116 when there is a large load. The metal fasteners 115, 116 are attachment points for the lift mechanism 110. It should be noted, that there will be multiple attachment points for the lift mechanism 110 even though only one is shown in this cross-sectional view.

The mold board 310 is formed from multiple layers of woven fabric and resin. Different types of woven fabric can be used. In one embodiment, a gelcoat is first applied to the mold board to provide protection from ultraviolet rays, and general abrasion, over the life of the mold board 310, followed by up to eight layers of Kevlar to form the front face of the mold board 310. The front face of the mold board 310 can be formed by vacuum bagging the mold board and infusing the resin into the structure. The horizontal beams 320, 340 can be formed in the same way as an addition to the completed mold board front face. The horizontal beams 320, 340 typically start with a foam core material. The foam core stiffeners 350 are also formed in the same way, in one embodiment. Finally, up to eight additional layers of Kevlar are added to the assembly and vacuum formed as previously described to form the back face of the mold board 310.

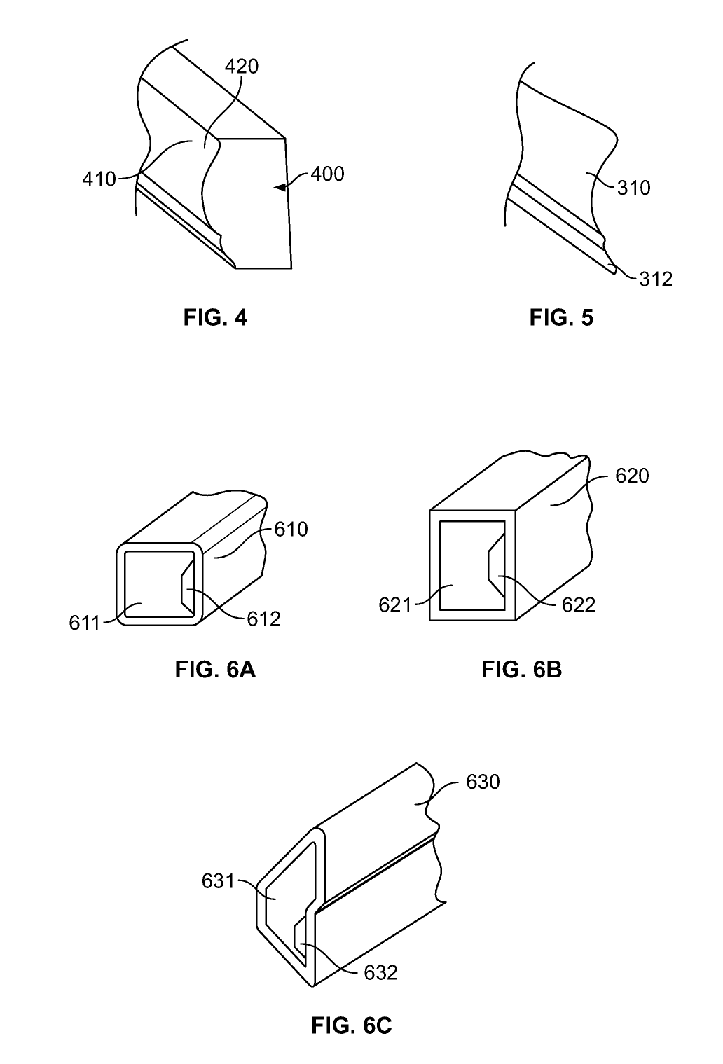

Now turning to the FIGS. 4-10, the method for forming the mold board 310, the horizontal beams 320, 340, and the stiffeners 350 and the composite snow plow will be discussed. FIG. 4 is a rear perspective view of a mold 400 for making a composite snow plow, and more specifically, the mold board 310, according to an example embodiment. Of course, manufacturing parts from composite materials begins with the mold 400, which is a negative of the part being produced. The part, or the mold board 310 in this instance, is constructed on the mold 400. The mold 400 is formed from foam blocks that are shaped to the final dimensions of the part, such as the mold board 310. The mold is then covered with woven fabric and resin to provide a smooth mold face 420. The mold board 310 can then be formed on the mold. The woven fabric and resin outer surface 410 on the mold face 420 allows for release of the mold board 310 after it has been formed. In one embodiment, the mold outer surface 410 is formed using up to 12 layers of woven fabric and resin, which is subsequently cured and sanded to a Class A surface finish. Multiple layers of woven fabric material and resin are applied to the front face 410 of the mold 400 to form the front face of the mold board 310. The layers can span the entire height and width of the finished mold board 310. The inner layers can be carbon fiber for higher stiffness and lighter weight. The inner layers could also be a lower grade material such as fiberglass. The lower grade material would be used to reduce cost. In one embodiment, the initial layers are cured. In another embodiment, the initial layers are not cured and other portions of the finished composite blade are added. When not cured, the bond between the initial and subsequent layers and parts of the composite blade are more deeply bonded when compared to a composite blade formed after the initial layers are cured before the rest of the composite snowblade is formed on the mold board 310.

FIG. 5 is a rear perspective view of a mold board portion 310 of a composite snow plow blade 300, according to an example embodiment. FIG. 5 shows the mold board 310 after it has been released from the mold 400. The mold board 310 includes a cavity or area 312 which receives the wear strip 302 along the bottom edge of the mold board 310. The transition area between the front face 340 of the mold board 310 and the cavity for receiving the wear strip is referred to as a joggle.

FIGS. 6A, 6B, and 6C are side perspective views of various horizontal beams for use in forming a composite snow plow, according to several example embodiments. As shown by FIGS. 6A, 6B, and 60 the cross-sectional shape of the horizontal beams and can be square, rectangular, triangular or trapezoidal. In addition it is contemplated, that the horizontal beams 610, 620, 630 could also have other cross-sectional shapes. The horizontal beams 610, 620, 630 span the entire width of the mold board 310 and provide an overall plate stiffness to the composite snow plow blade 300. The horizontal beams 610, 620, 630 also transmit any impact loads to the plate pivot axis and trip springs of the lift mechanism 110. The ends of the horizontal beams 610, 620, 630 are mitered at an angle to minimize stress concentrations. In one embodiment of the invention the miter angle is approximately 45°. The horizontal beams 610, 620, 630 include a foam core 611, 621, 631, respectively. The foam core 611, 621, 631 is the starting point for formation of the horizontal beams. The foam core is then wrapped with a woven fabric such as carbon fiber, Kevlar or fiberglass. The woven fabric is then impregnated with a resin to form a composite matrix. The horizontal beams 610, 620, 630 are placed in a bag and the vacuum is drawn on the bag to compress the various layers of woven fabric and resin, minimizing voids and removing excess resin to maximize the strength of the finished part. This process is referred to as vacuum bagging. In an alternative embodiment, the layers of composite material are wrapped around an inflatable bladder. The bladder is inflated to press the layers of composite material against the inside of a female mold. In a third alternative embodiment, the composite matrix is left to cure in open air, without vacuum assistance. This process is referred to as a hand layup.

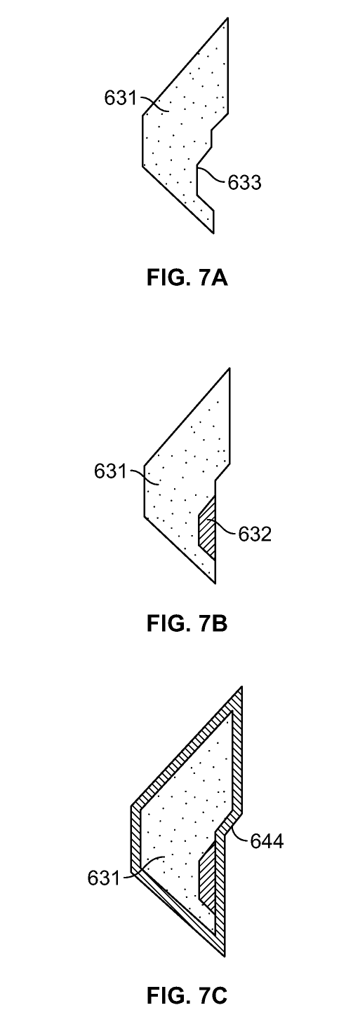

FIGS. 7A, 7B and 7C shows a series of cross-sectional views of the horizontal beam 630 while it is being manufactured or formed, according to an example embodiment. The other horizontal beams 620, 610 are similarly formed to the horizontal beam 630. Rather than describe the manufacturing process for forming each of the horizontal beams 610, 620, 630 only one will be described here for the sake of brevity of this description. FIG. 7A shows the initial step in the manufacturing process of the horizontal beam 630. The initial step is to shape the foam core 631 using hotwire or similar power tools. As shown in FIG. 7A, the foam core 631 includes an insert cavity 633. The next step in the manufacturing process is shown by FIG. 7B where the hard point strip 632 is placed into the cavity 633 of the foam core 631. The hard point strip 632 is bonded to the foam core 631. As mentioned previously, the hard point strip 632 can be a single length of material or can be formed of several shorter segments of material. The material is a metal such as aluminum or steel or the like. FIG. 7C shows yet another step in the formation of the horizontal beam 630. The foam core 631 and the metal insert 632 are wrapped with several layers of resin matrix impregnated woven fabric. The wrapped foam core is then cured using the vacuum bag technique or vacuum infusion technique. In other words the structure shown in FIG. 7C is cured using either the vacuum bag technique or vacuum infusion technique described previously. In another embodiment, the insert cavity 633 and the hard point strip 632 would not be utilized.

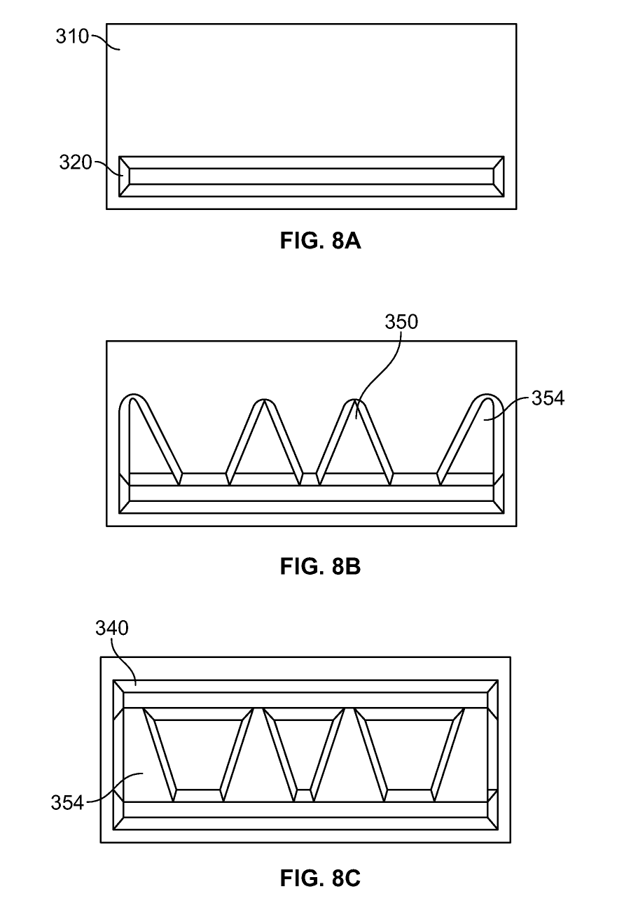

FIG. 8A is a rear view of a mold board with the lower horizontal beam attached, according to an example embodiment. FIG. 8B is a rear view of a mold board with the lower horizontal beam and a set of foam core stiffeners attached, according to an example embodiment. FIG. 8C is a rear view of a mold board with the lower horizontal beam, the set of foam core stiffeners, and an upper horizontal beam attached, according to an example embodiment. Now referring to FIGS. 8A-8C, the formation of the composite snow plow blade 300 will be further discussed. As shown by FIG. 8A, the mold board 310 is provided with a lower horizontal beam 320 having a cross-sectional shape such as is shown in FIGS. 6A, 6B or 6C. The lower horizontal beam 320 is bonded to the mold board 310. The mold board 310 includes a joggle 314. The lower horizontal beam 320 also includes a joggle 644. The joggle 644 is shown in FIG. 7C. The joggle 644 in the horizontal beam 320 is aligned with the joggle 314 in the mold board 310. In another embodiment, the horizontal beam joggle 644 and mold board joggle 314 would not be utilized.

As shown in FIG. 8B, substantially triangularly shaped foam core stiffeners 350 are aligned to the bottom edge of the lower horizontal beam 320. Other triangularly shaped foam core stiffeners 354 are provided along the side edges of the mold board 310. The foam core stiffeners 354 are also aligned to the bottom edge of the lower horizontal beam 320. FIG. 8C shows that an upper horizontal beam 340 is attached to the mold board assembly 310. The bottom edge of the upper horizontal beam 340 is aligned with the top edge of the triangularly shaped stiffeners 350, 354. The edges of the foam core stiffeners 350, 354 are also mitered to reduce stress and to simplify the addition of additional composite fiber fabric layers. In another embodiment, one continuous foam core stiffener would be utilized in lace of the triangular shaped foam core stiffener, 350, 354 and upper horizontal beam 340. The remaining step is to add additional layers of fabric as necessary. The fabric could be carbon fiber or Kevlar for higher stiffness and lighter weight or fiberglass for lower-cost. In addition, in other embodiments the type of fabrics could be mixed. As with the mold board 310, layers of additional fabric will be placed over the backside of the structure shown in FIG. 8C. The number of layers that are placed on the backside of the structure shown in FIG. 8C results in a composite snow plow blade 300 which is sufficiently strong to withstand impact loads and other loads necessary to plow snow in winter conditions.

A final layer can be placed on the composite snow plow blade 300 for cosmetic purposes. For example, carbon fiber pattern weave could be placed as a final layer to show a cosmetic weave. In another embodiment the gel coat could be applied for greater abrasion resistance and for protection from ultraviolet light sources such as the sun. The completed assembly is cured using the vacuum bagging technique or vacuum infusion technique. For maximum strength and performance with minimal weight, curing could be done inside an autoclave under carefully controlled heat and pressure environment. The completed composite snow plow blade 300 is removed from the vacuum bag or autoclave after curing is complete. The outside edges of the composite snow plow blade 300 are trimmed to produce a smooth and clean finish. Holes are drilled for the wear strip 302 as well as for the mounting plate of the lifting mechanism 110.

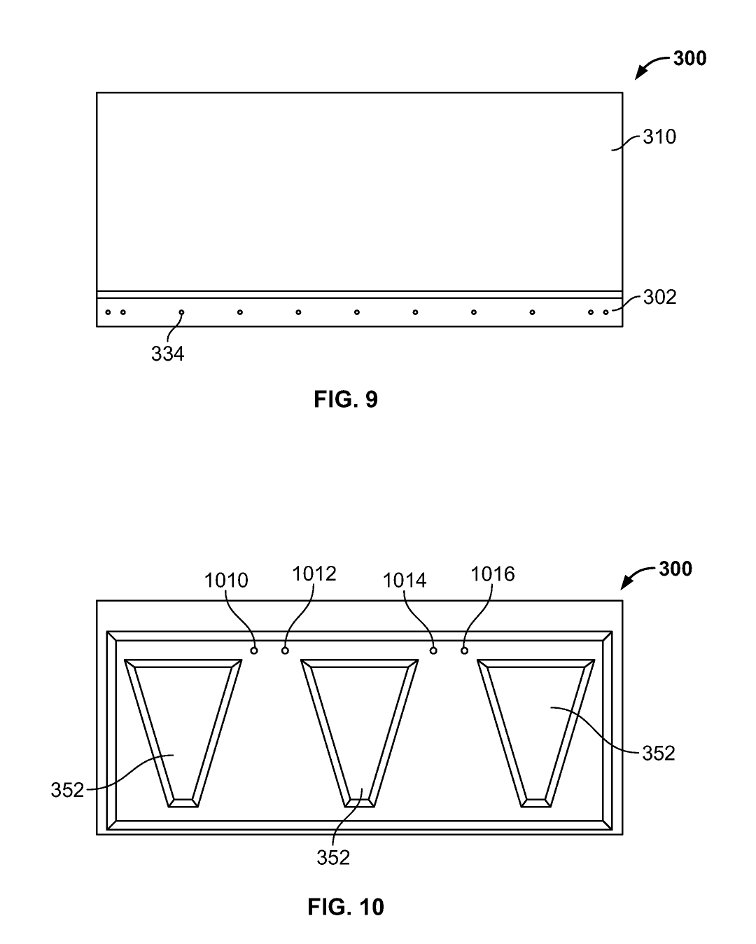

FIG. 9 is a front view of the finished composite snow blade 300, according to an example embodiment. As shown in FIG. 9, the wear strip 302 has been installed on the front face of the mold board 310. The wear strip 302 is attached to the composite snow plow blade 300 metal inserts, such as insert 322 as shown in FIG. 2, or with simple through-bolts if metal inserts are not utilized. As shown in FIG. 9 a plurality of fasteners 334 can be seen along the front face of the completed composite snow plow blade 300.

FIG. 10 is a rear view the finished composite snow blade 300 of FIG. 9, according to an example embodiment. As shown in FIG. 10, the rear of the snow blade is provided with openings 1010, 1012, 1014, 1016 so that the lifting mechanism 110 can be attached to the composite snow plow blade 300. The details of the attachment are shown in FIG. 3.

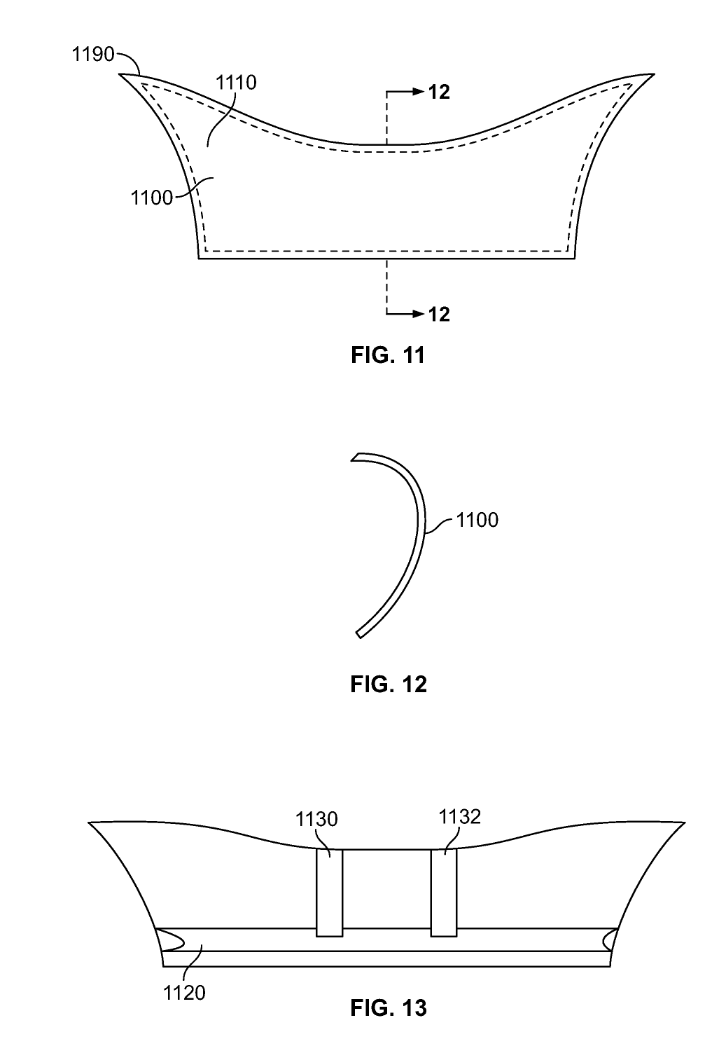

FIG. 11 is a front view of the finished composite snow blade 1100, according to another example embodiment. FIG. 12 is a cross-sectional side view of the finished composite snow blade 1100 along the cut line 12-12 in FIG. 11. The composite snow blade 1100 has a different shape. The process by which the composite snowplow blades are formed provides for much more flexibility in determining the shapes of the snow plow blades. As shown in FIG. 11, the composite snowplow blade 1100 includes a non-constant taper in the shape of the blade. The advantage of a non-constant taper is to minimize choking of the snow as it moves along the plate surface. A path of least resistance is then provided for the snow while it is being plowed. Choking of the snow often occurs with a straight blade. Choking occurs when the snow is not fully pushed to the side, resulting in snow blowing over the top of the blade instead of being pushed to the side. This is a problem with larger snowfalls, and is currently compensated for by operators by taking lesser swaths when plowing snow. This, of course, increases the length of time it takes to complete a job of snow removal. As shown in FIG. 11, the blade 1100 incorporates a radius that increases in a non-linear fashion from the center to the outer edges. In addition, a non-constant radius decreases from the bottom of the blade to the top of the blade as shown in FIG. 12. The outer vertical edges of blade 1100 are non-linear in shape. The blade 1100 gets wider from bottom to top near the outer edges so as to minimize piling of snow to the side of the vehicle while plowing. This provides a more efficient design that allows the user to save time by not having to take swaths lesser than a substantially full swath across a surface being plowed. The wider blade near the outer edge design also simplifies clearing of the snow during subsequent swaths. It should be noted that the complex geometry of the blade 1100 can be more easily fabricated using a composite material than using steel or another metal. In addition, design changes can also be more easily accommodated since the mold is changed to accommodate a design change. The complex design of the blade 1100 would be difficult to fabricate using a metal material given current manufacturing techniques used to form most snowblades. In one embodiment of the finished composite snow blade 1100 there is no foam core along the outer perimeter of the blade face. The lack of the foam core at the perimeter facilitates better bonding between the front and rear blade faces. Rather than run up to the outer edge of the blade, the foam core portions terminate about ½ to 2 inches from the edge of the outer perimeter of the blade 1100. The outer perimeter of the foam core is shown by dotted line 1190 in FIG. 11.

FIG. 13 is a rear view the finished composite snow blade 1100 of FIGS. 11 and 12, according to an example embodiment. After the mold board 1110 has been formed on a form or mold and cured, a horizontal beam 1120 and vertical horizontal beams 1130, 1132 are attached to the backside of the mold board 1110. The horizontal beams 1120, 1130, 1132 are formed prior to being placed on the mold board 1110. Additional foam core material can be added to further stiffen the overall blade face. The rear surface of the structure shown in FIG. 13. The rear surface is then layered with layers of woven fabric such as Kevlar or fiberglass to further build up the composite snow plow blade 1100. The complete layup assembly is then infused with resin via vacuum resin infusion process. The completed assembly is removed from the mold after cure. In one embodiment, the horizontal beams and the foam core material are provided with metal inserts to allow attachment of a wear plate as well as to allow attachment of a lift assembly to the backside of the completed composite snow blade 1100. The final layers of the composite snow blade 1100 can be selected so as to produce an aesthetic appeal. One final layer may include a gelcoat which is used to improve the cosmetic appearance and also provide additional protection from ultraviolet light.

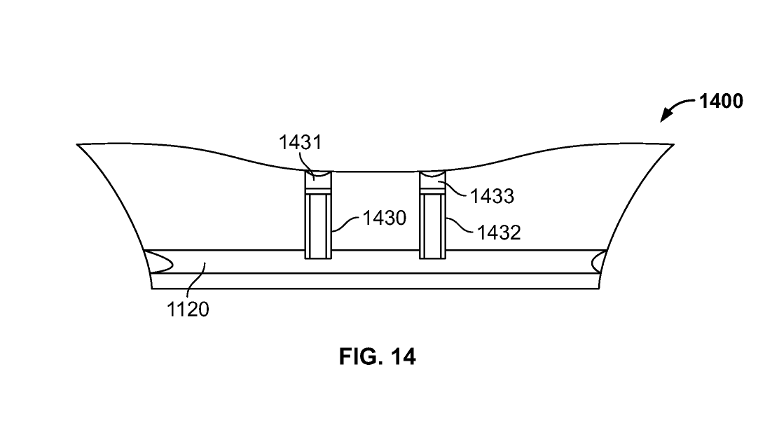

FIG. 14 is a rear view of the finished composite snow blade 1400, according to yet another example embodiment. The finished composite snow blade 1400 is very similar to the finished composite snow blade 1100. The finished composite snow blade 1400 includes slots for receiving a spring mounting plate of the lift system 110. Rather than discuss all similarities between the formation of snow blades 1100 and 1400, the following discussion will center on the differences between their formation. To provide a slot for the spring mounting plate of the lift system 110, the vertical stiffening ribs 1430, 1432 are cut with a saw blade. The stiffening ribs 1430, 1432 are cut so that a slot is formed. The slot 1431 is filled with modeling clay. The slot 1433 is also filled with modeling clay. The final layup of multiple layers of woven fabric such as Kevlar or fiberglass then takes place. In other words, the layers of fabric are placed over the rear surface of the composite blade 1400 and over the modeling clay in the slots 1431, 1433. The whole assembly is also cured in the same way as the blade 1100. The final steps in forming the plate 1400 are similar to the final steps in forming the blade 1100. An additional step includes cutting the final layer of woven fabric and removing the clay found in the slots 1431 and 1433. The slots are shaped to receive the spring mechanism of the lift mechanism 1110. The modeling clay prevents the slots from being filled with resin material during manufacture.

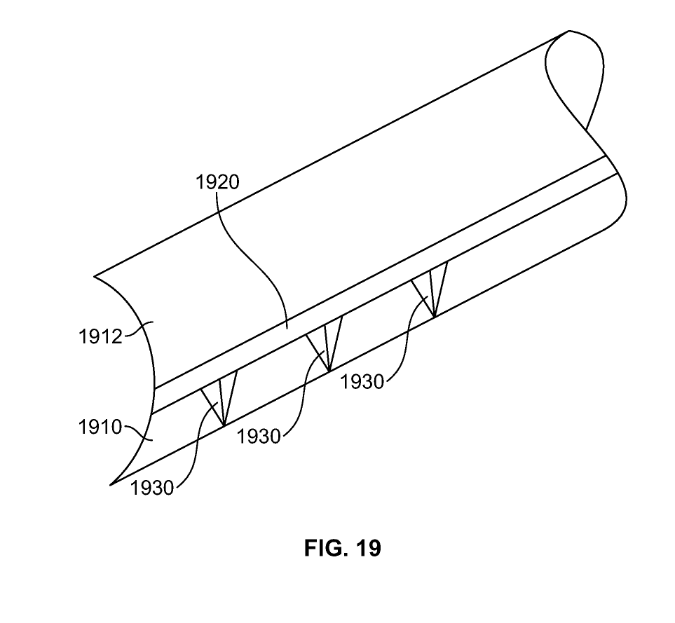

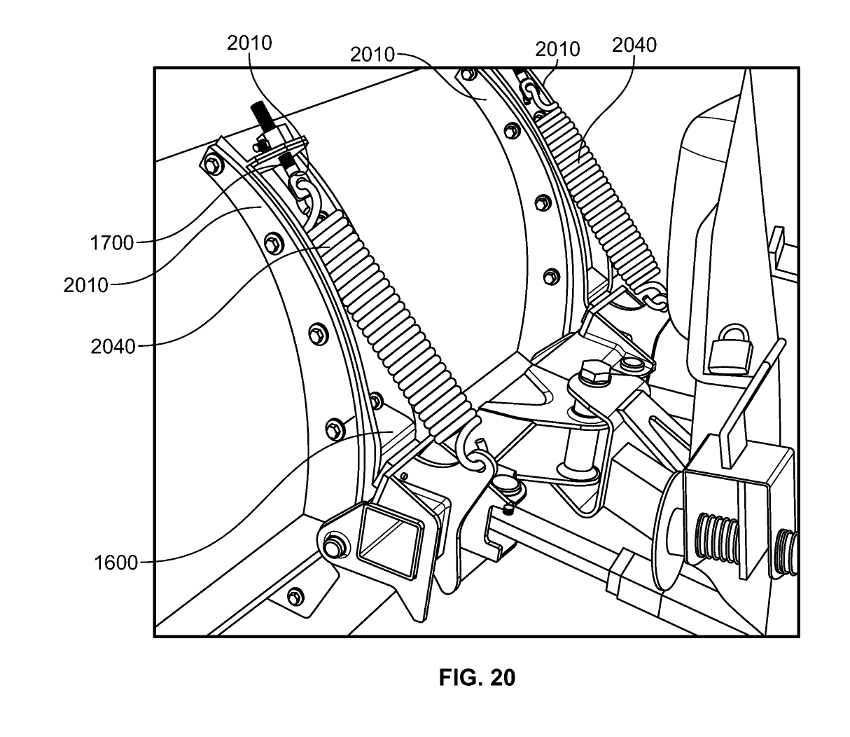

FIG. 19 is a perspective view of several reinforcing portions 1930 at or near the lower edge 1910 of the back side 1912 of the snow blade, according to an example embodiment. FIG. 19 shows the bottom portion 1910 of the backside 1912 of the backside of the snowblade. A high stress area is formed at in the region 1910 and, more specifically, at the interface of the substantially horizontal beam 1920 and the backside of the blade 1912. Reinforcement portions 1930 are placed between a lower horiziontal beam 1920. In one embodiment, the reinforcement portions 1930 have a core of a first material and are covered with woven material and infused with resin. The reinforcement portions span or bridge the area from a top portion or outermost ridge of the horizontal beam 1920 and across the lower portion 1910 of the blade. The reinforcement portions are diamond-shaped as shown in FIG. 19. It should be noted that the reinforcement portions 1930 could also have other shapes. The reinforcement portions 1930 taper down to the surface of the backside 1912 of the blade as shown. The reinforcement portions 1930 are also spaced to accommodate the connections between the interface assembly (shown in FIG. 20) and the composite snow blade.

It should be noted that the composite snow plow blades can be made in any type of configuration. For example, v-shaped snow plow blades can be formed of composite material. All sorts of cross sectional shapes are also capable of being formed using the above described methods.

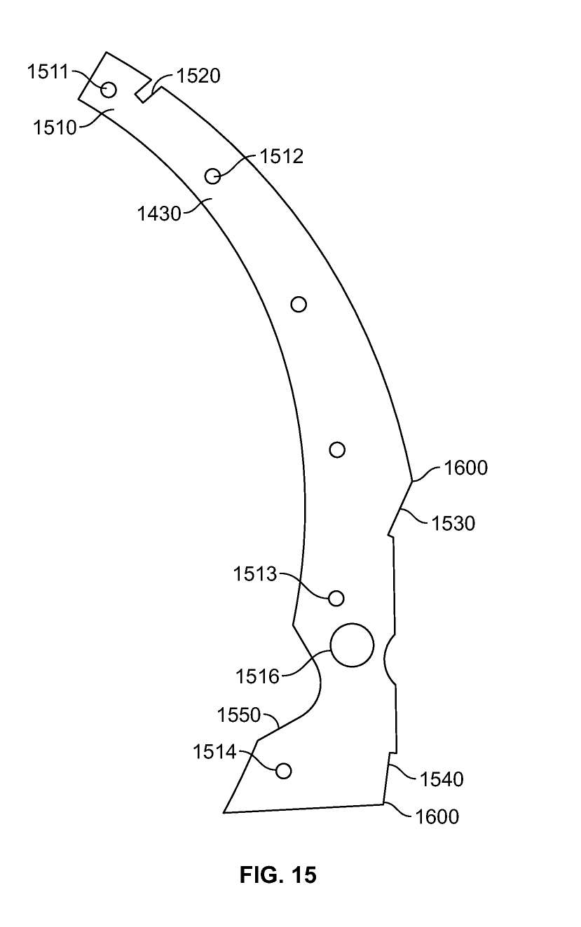

FIG. 15 is a side view of one of the support ribs used to make up the interface assembly 1500 (shown in FIG. 20) to attach to the vertical mounting ribs 2010 (shown in FIG. 20), according to yet another example embodiment. FIG. 20 shows the support ribs 1510 of the interface assembly 1500 attached to the vertical mounting ribs 2010 and 2012 of the snowplow blade . It should be noted that it takes two support ribs 2010 are attached to the mounting ribs 2010 of the blade to support for the snow plow blade. There are two sets of blade support ribs 2010 shown in FIG. 20. It should be noted that there can be additional sets of vertical mounting ribs 2010 can be added to a particular design of snowblade without varying from the scope of the invention. Now turning back to FIG. 15, the support rib is a substantially arcuately-shaped bracket 1510 that includes a first slot 1520, a second slot 1530 in the third slot 1540 on one side of the bracket 1510. The support rib or bracket 1510 also includes a plurality of openings 1511, 1512, 1513, 1515 which have an equal diameter or substantially equal diameter. These openings are sized to receive fasteners. These openings also align with openings in the vertical mounting ribs 2010 of the blade. The support bracket 1510 also includes a larger opening 1516. This opening receives a sleeve and a pivot axis about which the blade rotates. Each of the support ribs or brackets 1510 have a similar geometric shape when viewed from the side. Two support brackets 1510 are paired or connected to one another to form a portion of the interface apparatus which is used to attach the composite snowplow blade to a vehicle.

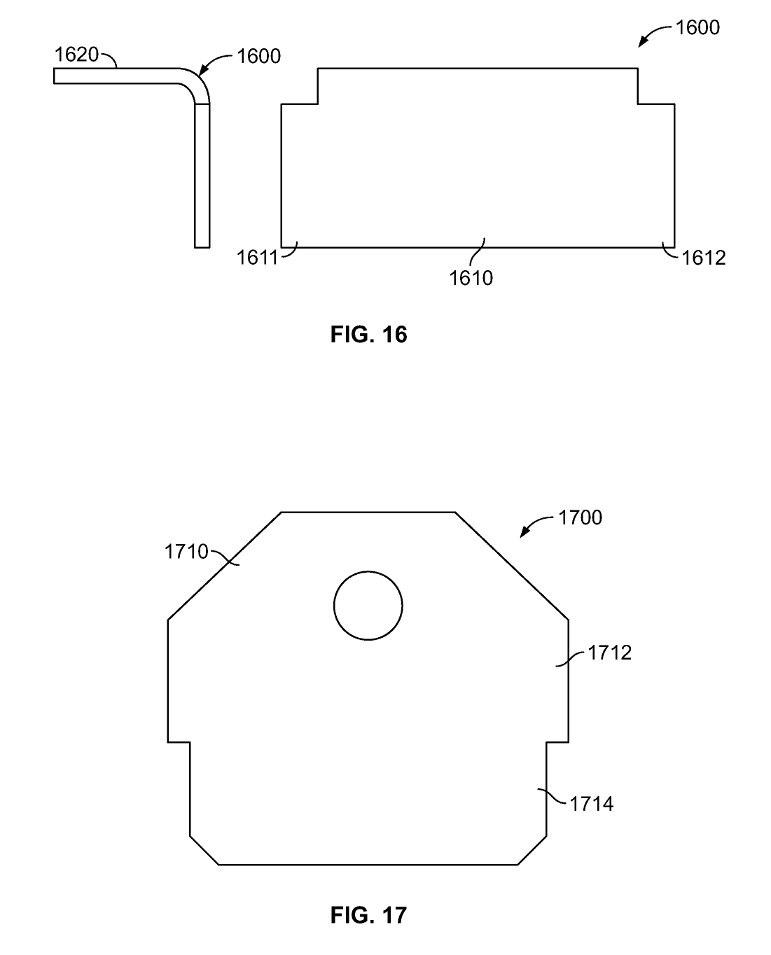

FIG. 16 is an elevational view of a stop plate 1600 and a cross-sectional view of the stop plate 1600, according to an example embodiment of the invention. The stop plate 1600 includes a main body 1610 which includes a first wing 1611 and the second wing 1612. The stop plate 1600 also includes a stop portion 1620 which is substantially orthogonal to the main body 1610 of the stop plate 1600.

FIG. 17 is an elevational view of a spring plate 1700, according to an example embodiment. The spring plate 1700 includes a trapezoidal portion 1710, a first angular portion 1712 and a second rectangular portion 1714. A spring 2040 is attached to the spring plate 1700. The spring 2040 generally applies a spring force to the blade through the interface mechanism and urges the blade to a position where the top stop plate 1600 remains in close proximity to a similarly shaped plate on the interface mechanism.

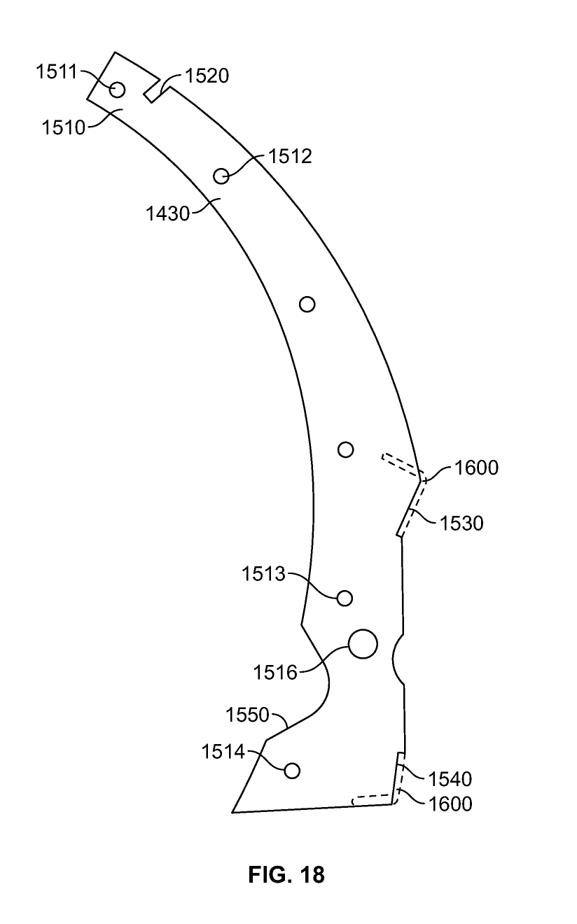

FIG. 18 is a side view of two arcuately-shaped support brakets 1510 are attached to one another using several components, according to an example embodiment. The stop plate 1600 is placed into a slot 1530 of the first arcuately- shaped support bracket 1510 and a second arcuately shaped bracket. The wing portions 1611, 1612 are attached to the support rib or bracket 1510. In one embodiment the stop bracket 1600 is attached to the rib by welding. Similarly another stop bracket 1600 is attached to the rib portion in the slot 1540 to form a lower stop.

In operation, the snowplow linkage provides for at least two safety positions in the event that the blade should encounter an obstruction. The brackets 1600 act as stops for the rotational motion of the snowplow blade when snowplow blade encounters an obstruction. In a first position the lower stop bracket 1600 pivots upwardly and impacts or strikes or otherwise contacts the linkage for attaching the snowplow blade to a vehicle. Generally, this is the position of the blade during most of the operational times of plowing snow. If the snow blade contacts an obstruction, the springs allow the blade to rotate thereby preventing breakage of the blade. The lower stop bracket 1600 (in slot 1540) prevents further motion of the snowplow blade and also prevents the linkage from damaging the snowplow blade. Similarly the stop bracket 1600 placed in slot 1530 acts as a stop when the snowplow blade rotates in a clockwise direction as shown in FIG. 18. The stop bracket 1600 impacts or strikes or otherwise contacts the linkage for attaching the snowplow blade to the vehicle. The stop bracket 1600 prevents further motion of the snowplow blade and also prevents the linkage from damaging the snowplow blade.

A snow plow system includes a composite blade, and a lift mechanism having one end attached to the composite blade for raising and lowering the composite blade. The lift mechanism has another end adapted to be attached to a vehicle. The snow plow system also includes a light system for positioning at least one headlamp above the blade. The inner radius of the snow plow blade varies across the snow moving surface of the snow plow blade. In one example embodiment, the inner radius of the snow plow blade increases in a non-linear fashion from the center of the snowplow blade to the outer edges. At substantaially the center of the blade, the radius of the snow plow blade is the least. The radius is greater as the snow plow blade approaches the edges. The composite blade includes a core of material substantially surrounded by woven fabric impregnated with resin. The composite blade woven fabric impregnated with resin wrapped over a core of material to form a composite blade. The composite blade further includes strengthening elements made of a core material and applied to the backside of the blade, and metal inserts positioned in at least one of the strengthening elements. In one embodiment, at least some of the strengthening elements are substantially vertical while in another embodiment, the strengthening elements are substantially horizontal. In still another embodiment, the strengthening elements can be both horizontal and vertical to form a matrix of strengthening element. A pair of substantially vertical brackets attached to a strengthening element of the blade near one end, and attached to the snow plow lifting mechanism at the other end. The pair of substantially vertical brackets includes at least one stop bracket. In one embodiment there is a lower stop element and an upper stop element that limits the rotational motion of the plow assembly and specifically of the blade. The stops also prevent portions of the attachment mechanism from harming the composite blade.

A snow plow apparatus adapted for attachment to a vehicle includes a core formed from a first material, a second material covering the core, and a resin infused into the second material and cured to form a composite material main body of the blade. A wear strip of a third material is attached along a lower portion of the main body of the blade. The wear strip provides a wear surface to prevent wear of the main body of the blade. The snow plow apparatus also includes a set of support brackets attached to the blade. The support brackets support the blade and also include at least one attachment element adapted for attaching a lifting mechanism to the support brackets, and at least one stop for limiting motion of the main body of the blade with respect to the lifting mechanism. In one example embodiment, the core material includes at least one stabilizer made of the second core material which, when covered with the second material and infused with resin, provides a portion for receiving at least one set of support brackets. The snow plow apparatus can be formed to include a raised portion for receiving at least one set of support brackets. The core material includes at least one of a foam, balsa wood or honeycomb material. In other embodiments, the core material includes at least two of a foam, balsa wood or honeycomb material. The snow plow apparatus can also include at least one metal insert positioned in at least one of the strengthening elements, the bracket attaching to at least one metal insert. The metal inserts are threaded in one embodiment. The core material includes a snow moving surface.

A method for forming a composite blade includes forming a main body as a core of a first material, adding strengthening elements to the core of first material, covering the main body and strengthening elements with woven fabric, and infusing the fabric with a resin material. This forms a composite blade including a core of first material, at least one strengthening element of another material. The method also includes adding at least one mounting bracket to the main body to allow attachment of the composite blade to a vehicle.

This has been a detailed description of some exemplary embodiments of the invention(s) contained within the disclosed subject matter. Such invention(s) can be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which shows by way of illustration, but not of limitation, some specific embodiments of the invention, including a preferred embodiment. These embodiments are described in sufficient detail to enable those of ordinary skill in the art to understand and implement the inventive subject matter. Other embodiments can be utilized and changes can be made without departing from the scope of the inventive subject matter. Thus, although specific embodiments have been illustrated and described herein, any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A snow plow system comprising:
a composite blade; and
a lift mechanism having one end attached to the composite blade for raising and lowering the composite blade, the lift mechanism having another end attached to a vehicle.

2. The snow plow system of claim 1 further comprising a light system for positioning at least one headlamp above the blade.

3. The snow plow system of claim 1 wherein the inner radius of the snow plow blade varies across the snow moving surface of the snow plow blade.

4. The snow plow system of claim 3 wherein the inner radius of the snow plow blade increases in a non-linear fashion from the center of the snowplow blade to the outer edges.

5. The snow plow system of claim 1 wherein the composite blade includes a core of material substantially surrounded by woven fabric impregnated with resin.

6. The snow plow system of claim 1 further comprising:
woven fabric impregnated with resin wrapped over a core of material to form a composite blade, the composite blade further including:
strengthening elements made of a core material and applied to the backside of the blade; and
metal inserts positioned in at least one of the strengthening elements.

7. The snow plow system of claim 6 wherein the strengthening elements are substantially vertical.

8. The snow plow system of claim 6 wherein the strengthening elements are substantially horizontal.

9. The snow plow system of claim 1 further comprising a pair of substantially vertical brackets attached to a strengthening element of the blade near one end, and attached to the snow plow lifting mechanism at the other end.

10. The snow plow system of claim 9 wherein the pair of substantially vertical brackets includes at least one stop bracket.

11-18. (canceled)

19. A method for forming a composite blade comprising:
forming a main body as a core of a first material;
adding strengthening elements to the core of first material;
covering the main body and strengthening elements with woven fabric;
infusing the fabric with a resin material, thereby forming a composite blade including a core of first material, at least one strengthening element of another material; and
adding at least one mounting bracket to the main body to allow attachment of the composite blade to a vehicle.
